(19) United States
(12) Patent Application Publication
(10) Pub. No.: US 2026/0056760 A1
(43) Pub. Date: Feb. 26, 2026

(54) METHOD AND APPARATUS FOR CONTROLLING INTEGRATION BETWEEN A WEARABLE DEVICE AND A VEHICLE

(71) Applicants: HYUNDAI MOTOR COMPANY, Seoul (KR); KIA CORPORATION, Seoul (KR)

(72) Inventor: Seong Soo Yae, Hwaseong-si (KR)

(73) Assignees: HYUNDAI MOTOR COMPANY, Seoul (KR); KIA CORPORATION, Seoul (KR)

(21) Appl. No.: 19/082,795

(22) Filed: Mar. 18, 2025

(30) Foreign Application Priority Data
Aug. 21, 2024 (KR) 10-2024-0111903

(51) Int. Cl. G06F 9/451; H04W 4/02; H04W 4/40

(52) U.S. Cl. CPC G06F 9/451; H04W 4/025; H04W 4/40

(57) ABSTRACT

A method and apparatus for controlling integration between a wearable device and a vehicle are disclosed. The method includes: connecting the wearable device and the vehicle using wireless communication; building an app optimized for the wearable device based on attribute information of the wearable device and option information of the vehicle; obtaining location information of the wearable device; and sending an app deactivation command or an app deletion command to the wearable device based on the location information of the wearable device.

### CROSS-REFERENCE TO RELATED APPLICATION

The present application claims priority to Korean Patent Application No. 10-2024-0111903, filed on Aug. 21, 2024 in the Korea Intellectual Property Office, the entire contents of which are incorporated herein by reference.

### TECHNICAL FIELD

The present disclosure relates to a method and an apparatus for controlling integration between a wearable device and a vehicle. More specifically, the present disclosure relates to a method and an apparatus for controlling integration between a wearable device and a vehicle, wherein the vehicle takes the control initiative in integration with the wearable device.

### BACKGROUND

The statements in this section merely provide background information related to the present disclosure and do not necessarily constitute prior art.

Wearable device technology is advancing rapidly and gaining widespread adoption. Wearable devices, including smart watches, smart glasses, and smart rings, may provide a wide range of information to users throughout their daily lives. One of the functions of wearable devices is to control or monitor various functions inside a vehicle through vehicle integration.

Traditionally, smartphones and vehicles are connected via Bluetooth or Wi-Fi. However, errors or security issues in smartphones affect the vehicle system, leading to malfunction of the navigation system of the vehicle or leakage of personal information. Moreover, vehicle control via smartphones is limited to only several functions, which do not fully satisfy the user experience.

Currently, there are no well-defined criteria or standards for the integration between a wearable device and a vehicle. Also, if an external device controls critical functions of the vehicle, security vulnerabilities or the risk of accidents due to improper operation may increase. Accordingly, the vehicle should have the control initiative for integration with wearable devices and be capable of directly managing the use and control of the wearable devices.

### SUMMARY

Objects of the present disclosure are to provide a method and an apparatus for a vehicle to control wearable devices, wherein the vehicle takes the control initiative in integration with the wearable devices.

The technical objects of the present disclosure are not limited to those described above. Other technical objects not mentioned above may be understood clearly by those having ordinary skill in the art from the descriptions given below.

An embodiment of the present disclosure provides a method for controlling integration between a wearable device and a vehicle. The method includes: connecting the wearable device and the vehicle using wireless communication; building a software program or application, i.e., an app optimized for the wearable device based on attribute information of the wearable device and option information of the vehicle; obtaining location information of the wearable device; and sending an app deactivation command or an app deletion command to the wearable device based on the location information of the wearable device.

Another embodiment of the present disclosure provides an apparatus for controlling integration between a wearable device and a vehicle. The apparatus includes at least one memory storing commands; and at least one processor. The at least one processor is configured to perform: connecting the wearable device and the vehicle using wireless communication; building an app optimized for the wearable device based on attribute information of the wearable device and an option information of the vehicle; obtaining location information of the wearable device; and sending an app deactivation command or an app deletion command to the wearable device based on the location information of the wearable device.

According to one embodiment of the present disclosure, a vehicle takes the control initiative in integration with wearable devices, thereby enabling the vehicle to directly manage the use of the wearable devices.

The technical effects of the present disclosure are not limited to the technical effects described above, and other technical effects not mentioned herein may be understood to those having ordinary skill in the art to which the present disclosure belongs from the description below.

### BRIEF DESCRIPTION OF THE DRAWINGS

FIG. 1 shows a block diagram of a wearable device control apparatus according to one embodiment of the present disclosure.

FIG. 2 is a flow diagram illustrating a process of registering a wearable device according to one embodiment of the present disclosure.

FIG. 3 is a flow diagram illustrating a process of pushing a software program or application, i.e., an app to a wearable device according to one embodiment of the present disclosure.

FIG. 4 is a flow diagram illustrating a process of instructing deactivation of an app based on monitoring of the location of a wearable device according to one embodiment of the present disclosure.

FIG. 5 is a flow diagram illustrating a process of instructing removal of an app based on monitoring of the app activation time according to the present disclosure.

FIG. 6 is a block diagram of a computing device that may be used for implementing the method or the apparatus according to the present disclosure.

### DETAILED DESCRIPTION

Hereinafter, some embodiments of the present disclosure are described in detail with reference to the accompanying drawings. In the following description, like reference numerals designate like elements, although the elements are shown in different drawings. Further, in the following description of some embodiments, a detailed description of known functions and configurations incorporated therein has been omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’, ‘has’, or ‘comprises’ a component, the part is meant to further include other components, not to exclude other components unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe embodiments of the present disclosure and is not intended to represent the only embodiments in which the present disclosure may be practiced. When a component, controller, system, module, unit, device, element, or the like (i.e., an element) of the present disclosure is described as having a purpose or performing an operation, function, or the like, the component, controller, system, module, unit, device, element, or the like should be considered herein as being “configured to” meet that purpose or to perform that operation or function. Each component, controller, system, module, unit, device, element, and the like may separately embody or be included with a processor and a memory, such as a non-transitory computer readable media, as part of the element.

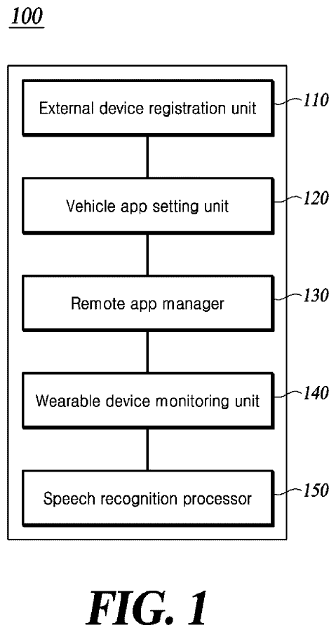

FIG. 1 shows a block diagram of a wearable device control apparatus 100 according to one embodiment of the present disclosure.

As shown in FIG. 1, the wearable device control apparatus 100 according to one embodiment of the present disclosure includes all or part of an external device registration unit 110, a vehicle app (i.e., a software program or application) setting unit 120, a remote app manager 130, a wearable device monitoring unit 140, and a speech recognition processor 150. Not all blocks shown in FIG. 1 are essential components and a portion of blocks included in the wearable device control apparatus 100 may be added, modified, or deleted in other embodiments. The constituting elements shown in FIG. 1 represent functionally distinct elements and at least one constituting element may be implemented in a form in which it is integrated with another element in the actual physical environment.

A user may get into a vehicle and register a wearable device to the external device registration unit 110. The user may register a wearable device directly inside the vehicle. The user may register a wearable device using a mobile phone application or a service webpage.

The external device registration unit 110 may search for a wearable device using short-range wireless communication, such as Wi-Fi or Bluetooth. The external device registration unit may then connect the wearable device to the vehicle via wireless communication.

A user may input information on a wearable device into a mobile phone using an application of the mobile phone. The external device registration unit 110 may search for a wearable device using the input wearable device information and automatically connect the wearable device to the vehicle. If the vehicle and the wearable device are automatically connected, the user has to approve the connection request from the vehicle.

When a wearable device is connected to the vehicle, a user may select an application and its temporary option, wherein the application may be used by application of the wearable device. In the present disclosure, the temporary option means an option that allows the user to decide whether to use an application continuously or temporarily.

The user may input information on the application to be used and its temporary option in advance using a mobile phone application.

When registering a wearable device, the user may set an application to be used by using the wearable device and select its temporary option. The user may decide whether to use all applications or a specific one. The user may select a temporary option for each application.

The user may freely change the information of a registered wearable device, applications available for the registered wearable device, and temporary options of the applications.

The process of registering a wearable device with the vehicle includes the process of the user approving the vehicle to control the wearable device. The vehicle's control rights may include the authority of the vehicle to force the installation of necessary applications on the wearable device, the authority of the vehicle to restrict the use of the applications of the wearable device, and the authority of the vehicle to delete the applications from the wearable device.

The vehicle provides all applications installed on the wearable device. The vehicle has the authority to restrict the use of the applications and to delete them. Therefore, the user has to go through an approval procedure for the control rights of the vehicle. Accordingly, the vehicle may maintain the initiative for the vehicle control over the wearable device.

When a wearable device is registered, the external device registration unit 110 may check the integration control option supported by the wearable device and store the wearable device's attribute information in the wearable device attribute database. The The supported feature option may include whether the wearable device supports speech recognition, whether the wearable device has a touchpad function, and whether the wearable device provides haptic feedback. The hardware support option may include information on the display size and support, resolution, presence of a microphone, availability of hard keys, and availability of a jog dial. The wearable device attribute information may include the wearable device's attribute information on the supported feature options and the hardware support options.

The external device registration unit 110 may search for a registered wearable device using the registration information of the wearable device. If a registered wearable device is detected around the vehicle, the external device registration unit 110 may automatically connect the registered wearable device to the vehicle. The external device registration unit 110 may use wireless communication to search for wearable devices.

In the present disclosure, the process of transmitting an app required for smooth integration between the vehicle and a wearable device and installing the app on the wearable device may be referred to as an app push.

The vehicle app setting unit 120 may generate an app that includes the functions of an application available based on the current vehicle options. The current vehicle options may include information on the vehicle options applied when the vehicle is manufactured. The information on the current vehicle options may be stored in a vehicle option database.

The vehicle app setting unit 120 may check the wearable device attribute information stored in the wearable device attribute database. The vehicle app setting unit 120 may check the control options that may be integrated with the vehicle using the wearable device attribute information. The control options allowed for integration with the vehicle may include supported feature options and hardware support options.

The vehicle app setting unit 120 may build an app that supports a wearable device by taking vehicle option information and wearable device attribute information into account. The vehicle app setting unit 120 may check the attribute information of the wearable device and select an application optimized for the wearable device.

The vehicle app setting unit 120 may transmit an app file optimized for the connected wearable device. The vehicle app setting unit 120 may instruct the wearable device to install the transmitted app.

Through the app push process, the user may obtain a different effect from the method of downloading an app from the app market. The user may efficiently utilize the storage space of the wearable device since the user does not have to download resource-intensive software which contains unnecessary functions. Since only the essential and usable functions are installed in the wearable device based on the vehicle option, the file size and functions of the app downloaded may vary depending on the vehicle option, even for the same vehicle type.

When a registered wearable device is connected to the vehicle, the vehicle app setting unit 120 may check whether there exists an app permitted to be additionally installed due to changes in the settings of the wearable device. The vehicle app setting unit 120 may check whether any apps have been additionally installed due to changes in the settings of the wearable device.

If the app installation is permitted but an app has not been installed yet, the vehicle app setting unit 120 may transmit an app file optimized for the connected wearable device and instruct the wearable device to install the app.

If a registered wearable device is connected to the vehicle, the vehicle app setting unit 120 may check whether an app may be deleted due to changes in the settings. If an app may be deleted due to changes in the settings, the vehicle app setting unit 120 may delete the app installed on the wearable device.

The remote app manager 130 may receive location information of the wearable device from the wearable device monitoring unit 140.

The remote app manager 130 may deactivate or delete the app of the wearable device based on the location and temporary options of the wearable device. Apps installed on the wearable device may include temporary apps and permanent apps.

In the present disclosure, a temporary app refers to an app downloaded and used when a wearable device is connected to the vehicle, and automatically deleted from the wearable device when the vehicle is turned off. When the vehicle and the wearable device are connected, the vehicle may automatically install the necessary temporary apps on the wearable device. When the vehicle is turned off, the wearable device may automatically delete the temporary apps. The temporary apps do not require separate control from the user. The temporary apps may include, for example, a digital key app related to vehicle ignition security.

In the present disclosure, a permanent app refers to an app automatically downloaded when a wearable device is registered with the vehicle, activated when the vehicle and the wearable device are connected, and deactivated when the wearable device is removed from the vehicle. When the wearable device is connected to the vehicle, the vehicle may automatically activate the permanent app. When the wearable device moves away from the vehicle, the vehicle may deactivate the permanent app. The permanent apps may include, for example, apps for controlling infotainment, navigation, and HVAC (Heating, Ventilation, and Air Conditioning) of the vehicle.

In one embodiment of the present disclosure, a rental car business operator may set all app attributes of wearable devices to be connected to the vehicle as temporary apps. When a registered wearable device is detected in the vehicle, and the rental car business operator has set the attributes of all apps of wearable devices in the vehicle as temporary apps, the vehicle may provide only the apps contracted for the wearable device. When the vehicle rental period ends, the wearable device control apparatus 100 may send an app deletion command to the connected wearable device.

When controlling the vehicle using a wearable device, the user may have to receive an integration signal from the vehicle to control the vehicle. If the integration signal is not received from the vehicle, the app controlling the vehicle is not activated. An inactive app is not visible on the wearable device.

When the wearable device moves out of the vehicle, the remote app manager 130 may detect the location of the wearable device and send an app deactivation command. The remote app manager 130 may send an app deactivation command to the wearable device using wireless communication. Even if the wearable device moves away from the vehicle at a high speed, the remote app manager 130 may send a command to the wearable device via Bluetooth or Wi-Fi. The remote app manager 130 may deactivate the app of the wearable device based on the speed of the vehicle.

The remote app manager 130 may have the authority to delete temporary apps. When the wearable device is separated from the vehicle and the vehicle engine is turned off, the remote app manager 130 may send a command to delete the temporary app.

The remote app manager 130 may send a temporary app deletion command to the wearable device depending on the needs and retrieve the authority held by the wearable device. After sending a temporary app deletion command to the wearable device, the remote app manager 130 deletes the integration with the wearable device app. To reuse the app deleted from the wearable device, the user has to re-register the app.

The remote app manager 130 may have the authority to deactivate apps on the wearable device. The remote app manager 130 may use the wearable device location monitoring unit to obtain the location information of the wearable device. The remote app manager 130 may detect whether the wearable device moves out of the vehicle and deactivate the apps installed on the wearable device. The remote app manager 130 deactivates the apps on the wearable device to prevent the user of the wearable device from controlling the vehicle from outside the vehicle.

The remote app manager 130 may limit the use of each app based on the driving speed. The vehicle transmits the current driving speed to the wearable device, and the wearable device determines whether to activate or deactivate each app based on the received speed.

The remote app manager 130 may distinguish whether each wearable device belongs to the driver or a passenger. The remote app manager 130 may control part of the functions of the app based on the location of the wearable device and the vehicle speed. The control settings for the vehicle speed and the boarding location are determined when each app is installed on the wearable device. The wearable device may limit the use of the app as the vehicle sends the current vehicle speed to the wearable device.

For example, the remote app manager 130 may control the apps on the wearable device to be deactivated when the driving speed exceeds 30 kilometers per hour (km/h), particularly for apps that deal with video content. In another example, the remote app manager 130 may control the wearable device to perform only speech-based operations when the driving speed exceeds 100 km/h. If a passenger uses a wearable device, the remote app manager 130 may allow the passenger to use all app functions regardless of the driving speed.

The wearable device monitoring unit 140 may check the location of the wearable device. The wearable device monitoring unit 140 may transmit the location information of the wearable device to the remote app manager 130.

The wearable device monitoring unit 140 may determine whether the wearable device is separated from the vehicle by using wireless communication between the vehicle and the wearable device. The wearable device monitoring unit 140 may check the distance between the wearable device and the vehicle using the signal strength of the wireless connection and the ping signal between the vehicle and the wearable device. The ping signal is a signal used to check the connection status and response time between two devices in a network or wireless communication system. The wearable device monitoring unit 140 may determine the distance or connection status between the vehicle and the wearable device by transmitting a ping signal to the wearable device and measuring the response time of the wearable device.

The wearable device monitoring unit 140 may detect the presence of a wearable device inside the vehicle using the vehicle's wireless antenna.

The method of determining whether a wearable device is separated from a vehicle using the signal strength and the ping signal is susceptible to interference from surrounding radio waves and may have errors if the wearable device is very close to the vehicle. Accordingly, the present disclosure proposes a method that complements the method of determining separation of a wearable device from a vehicle using wireless communication.

If a wearable device approaches a vehicle, the vehicle may recognize the wearable device through wireless communication and establishes a connection with the wearable device. The app that controls the vehicle is not immediately activated.

The remote app manager 130 sends an app activation message to the wearable device only after confirming the wireless signal strength, the wireless positioning, and that the vehicle doors are closed. For example, the remote app manager 130 may send an app activation message to the wearable device only after confirming that the signal strength between the vehicle and the wearable device is sufficiently strong, the wearable device is located inside the vehicle, and the vehicle doors are closed.

The remote app manager 130 may send an app deactivation command to the wearable device when the vehicle door is opened. By deactivating the app after confirming the opening of the vehicle door, it is possible to prevent the user from controlling the vehicle using the wearable device outside the vehicle.

The wearable device monitoring unit 140 may determine the location of the wearable device inside the vehicle. For example, the wearable device monitoring unit 140 may determine whether the driver is wearing a wearable device. In another example, the wearable device monitoring unit 140 may determine whether a passenger is wearing a wearable device.

The wearable device monitoring unit 140 may determine in which seat of the vehicle the wearable device is located. For example, the wearable device monitoring unit 140 may determine the specific seat in which the wearable device is located, such as the driver's seat, passenger seat, left seat of the second row, or right seat of the second row.

The wearable device monitoring unit 140 may transmit the confirmed location information to the wearable device. The wearable device may be restricted in the use of the app based on the confirmed location information. The confirmed location information of the wearable device may be stored in the wearable device location determination result database. The stored location information may be used by the remote app manager 130.

The speech recognition processor 150 may select whether to use the speech recognition of the vehicle or speech recognition of the wearable device.

If a wearable device with a speech recognition microphone positioned near the user's mouth is registered with a vehicle, the speech recognition processor 150 may use speech recognition of the wearable device. The wearable device may receive the user's speech command and preprocess the command. The preprocessing process may include, for example, a process of removing speech noise and a process of removing echo signals. The wearable device may transmit the preprocessed speech to the speech recognition processor 150. When the wearable device with a speech recognition microphone near the user's mouth is registered with the vehicle, the speech recognition processor 150 uses only the speech information transmitted by the wearable device and ignores the speech information collected by the vehicle.

If a wearable device without a speech recognition microphone or with a microphone positioned far from the user's mouth is registered with the vehicle, the speech recognition processor 150 may set the options that enable speech recognition of the vehicle. The speech recognition processor 150 uses speech data collected from the vehicle.

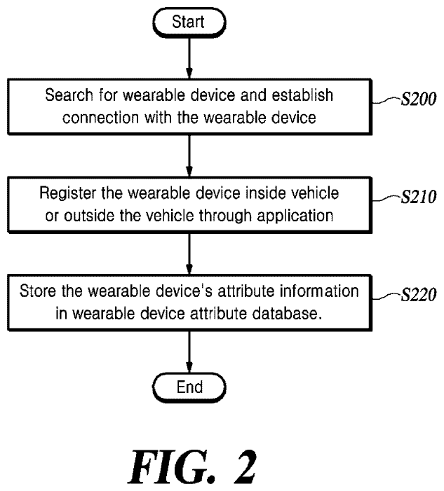

FIG. 2 is a flow diagram illustrating a process of registering a wearable device according to one embodiment of the present disclosure.

The wearable device control apparatus 100 may search for a wearable device and establish a connection with the wearable device using short range wireless communication, such as the Wi-Fi or Bluetooth (S200).

The user may input information on the wearable device into the mobile phone using an application of the mobile phone. The external device registration unit 110 may search for a wearable device using the input wearable device information and automatically connect the wearable device to the vehicle. If the vehicle and the wearable device are automatically connected, the user has to approve the connection request from the vehicle.

After getting into the vehicle, the user may register the wearable device with the vehicle (S210). The user may register the wearable device directly inside the vehicle or may register the wearable device outside the vehicle through a mobile phone application or a service webpage. When the wearable device is connected to the vehicle, the user may select an application and its temporary option, wherein the application may be used by application of the wearable device. In the present disclosure, the temporary option means an option that allows the user to decide whether to use an application continuously or temporarily.

When a wearable device is registered, the wearable device control apparatus 100 may check the integration control option supported by the wearable device and store the wearable device's attribute information in the wearable device attribute database (S220). The The supported feature option may include whether the wearable device supports speech recognition, whether the wearable device has a touchpad function, and whether the wearable device provides haptic feedback. The hardware support option may include information on the display size and support, resolution, presence of a microphone, availability of hard keys, and availability of a jog dial. The wearable device attribute information may include the wearable device's attribute information on the supported feature options and the hardware support options.

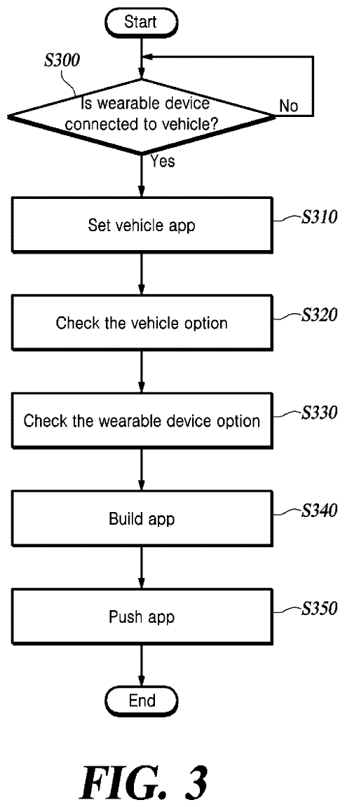

FIG. 3 is a flow diagram illustrating a process of pushing an app to a wearable device according to one embodiment of the present disclosure.

The wearable device control apparatus 100 may check whether the wearable device is connected to the vehicle (S300). If not connected (NO at S300), the wearable device control apparatus 100 will check for connection or will connect the wearable device to the vehicle.

The wearable device control apparatus 100, when the wearable device is connected to the vehicle (YES at S300), may set up an integration app for using the functions provided by the vehicle through the wearable device (S310). All the default settings of the integration app have the same size, based on the assumption that the vehicle is equipped with all available options. The vehicle app setting unit 120 may set up the integration app considering the functions that vary depending on the options provided by the vehicle. For example, the vehicle app setting unit 120 may rebuild the app to perform the functions that vary depending on the options of each vehicle. The process of rebuilding the app may include an optimization process of the app.

The wearable device control apparatus 100 may check the current vehicle options (S320). The current vehicle options may include information on the vehicle options applied when the vehicle is manufactured. The information on the current vehicle options may be stored in the vehicle option database.

The wearable device control apparatus 100 may check wearable device attribute information stored in the wearable device attribute database (S330). The vehicle app setting unit 120 may check control options that may be integrated with the vehicle using the wearable device attribute information. The control options that may be integrated with the vehicle may include support feature options and hardware support options.

The wearable device control apparatus 100 may build an app that supports a wearable device by considering vehicle option information and wearable device attribute information (S340). For example, the vehicle app setting unit 120 may build an app that includes a function supported by the vehicle, based on the vehicle option information. In another example, the vehicle app setting unit 120 may build an app that includes a function supported by the wearable device, based on the wearable device attribute information. In the present disclosure, the process of selecting an app by considering both vehicle option information and the wearable device attribute information is referred to as an optimization process.

The wearable device control apparatus 100 may transmit an app file optimized for the connected wearable device (S350). The wearable device control apparatus 100 may instruct the wearable device to install the transmitted app. The wearable device control apparatus 100 may select apps supported by the wearable device and instruct the wearable device to install the selected apps.

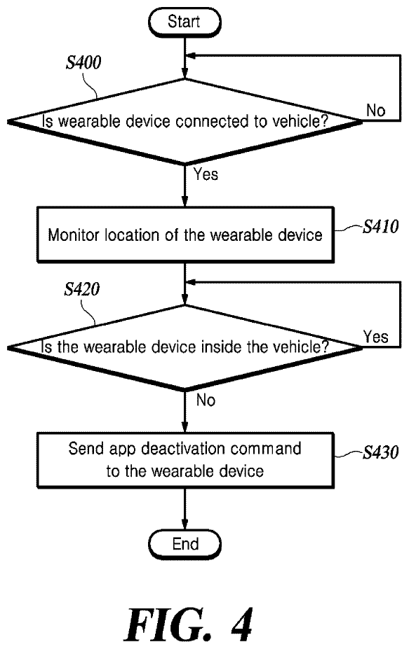

FIG. 4 is a flow diagram illustrating a process of instructing deactivation of an app based on monitoring of the location of a wearable device according to one embodiment of the present disclosure.

The wearable device control apparatus 100 may check whether the wearable device is connected to the vehicle (S400). If not connected (NO at S400), the wearable device control apparatus 100 will check for connection or will connect the wearable device to the vehicle.

When the vehicle and the wearable device are connected (YES at S400), the wearable device control apparatus 100 may check the location of the wearable device (S410).

The wearable device monitoring unit 140 may determine whether the wearable device is separated from the vehicle by using wireless communication between the vehicle and the wearable device. The wearable device monitoring unit 140 may check the distance between the wearable device and the vehicle using the signal strength of the wireless connection and the ping signal between the vehicle and the wearable device. The ping signal is a signal used to check the connection status and response time between two devices in a network or wireless communication system. The wearable device monitoring unit 140 may determine the distance or connection status between the vehicle and the wearable device by transmitting a ping signal to the wearable device and measuring the response time of the wearable device.

The wearable device control apparatus 100 may detect the presence of a wearable device inside the vehicle using the vehicle's wireless antenna (S420). If the device is not detected in the vehicle (NO at S420), the wearable device control apparatus 100 will continue to check. The wearable device control apparatus 100 may complement the method of determining the presence of a wearable device within the vehicle by checking the vehicle door information.

The wearable device monitoring unit 140, when the wearable device is detected in the vehicle (YES at S420), may determine the location of the wearable device inside the vehicle. For example, the wearable device monitoring unit 140 may determine whether the driver is wearing a wearable device. In another example, the wearable device monitoring unit 140 may determine whether a passenger is wearing a wearable device.

The wearable device monitoring unit 140 may determine in which seat of the vehicle the wearable device is located. For example, the wearable device monitoring unit 140 may determine the specific seat in which the wearable device is located, such as the driver's seat, passenger seat, left seat of the second row, or right seat of the second row.

The wearable device control apparatus 100 may send an app deactivation command to the wearable device based on the location of the wearable device (S430).

The wearable device control apparatus 100 may have the authority to deactivate apps on the wearable device. The wearable device control apparatus 100 may use the wearable device monitoring unit 140 to obtain the location information of the wearable device. The remote app manager 130 may detect whether the wearable device moves out of the vehicle and deactivate the apps installed in the wearable device. The wearable device control apparatus 100 deactivates the apps on the wearable device to prevent the user of the wearable device from controlling the vehicle from outside the vehicle.

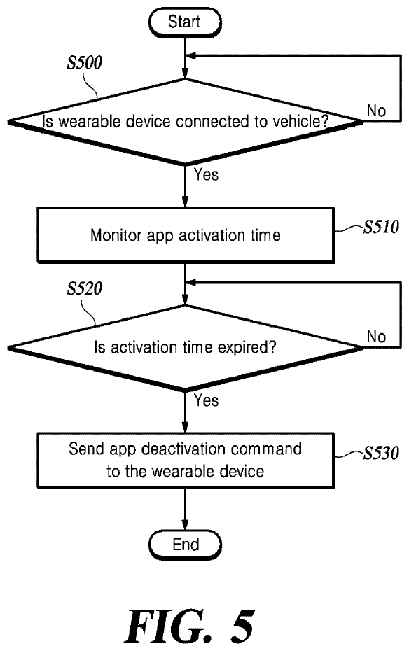

FIG. 5 is a flow diagram illustrating a process of instructing removal of an app based on monitoring of the app activation time according to the present disclosure.

The wearable device control apparatus 100 may check whether the wearable device is connected to the vehicle (S500). If not connected (NO at S500), the wearable device control apparatus 100 will check for connection or will connect the wearable device to the vehicle.

The wearable device control apparatus 100, when the wearable device is connected to the vehicle (YES at S500), may monitor the app activation time of the wearable device (S510). For example, the wearable device control apparatus 100 may check whether an app being installed on the wearable device is a temporary app or a permanent app.

The wearable device control apparatus 100 may determine whether the activation time of the app installed on the wearable device has expired (S520). For example, if the installed app is a temporary app, the wearable device control apparatus 100 may determine the expiration of the activation time of the app by checking when the vehicle engine is turned off. The temporary app may include, for example, a digital key app related to vehicle ignition security.

The wearable device control apparatus 100 may send a command to the wearable device to delete an app of which the activation time has expired (S530). For example, if the installed app is a temporary app, the wearable device control apparatus 100 may send a command to the wearable device to delete the app once the wearable device control apparatus 100 confirms that the activation time has expired (YES at S520) due to the vehicle engine being turned off. If the activation time has not yet expired (NO at S520), the wearable device control apparatus 100 will not send the command and will continue to check the activation time.

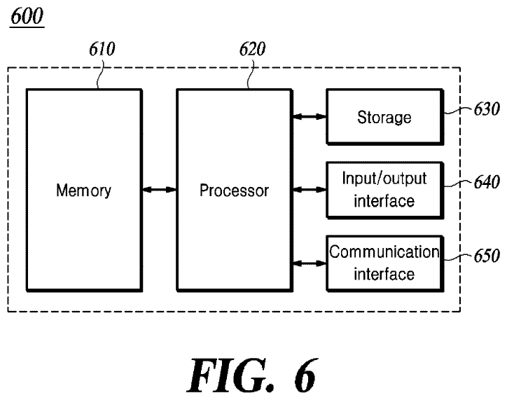

FIG. 6 is a block diagram of a computing device that may be used for implementing the method or the apparatus according to the present disclosure.

The computing device 600 may include all or part of a memory 610, a processor 620, storage 630, an input/output interface 640, and a communication interface 650. The computing device 600 may structurally and/or functionally include at least a portion of the wearable device control apparatus 100. The computing device 600 may be a stationary computing device, such as a desktop computer or a server, as well as a mobile computing device, such as a laptop computer, a smartphone, or an automotive electronic device. The computing device 600 may be implemented as an arbitrarily specialized hardware accelerator capable of efficiently processing operations devised for an artificial intelligence model. For example, the computing device 600 may include a graphics processing unit (GPU), a Tensor Processing Unit (TPU), or a neural processing unit (NPU).

The memory 610 may store a program that enables the processor 620 to perform methods or operations according to various embodiments of the present disclosure. For example, the memory 610 may store a wearable device attribute database, a vehicle option database, and a wearable device location determination result database. In another example, a program may include a plurality of instructions executable by the processor 620, and the methods or operations described above may be performed by executing the plurality of instructions by the processor 620. The memory 610 may consist of a single memory or a plurality of memories. In this case, information required to perform the methods or operation according to various embodiments of the present disclosure may be stored in a single memory or distributed across a plurality of memories. When the memory 610 is composed of a plurality of memories, the plurality of memories may be physically separated. The memory 610 may include at least one of volatile memory and non-volatile memory. Volatile memory includes Static Random Access Memory (SRAM) or Dynamic Random Access Memory (DRAM), while non-volatile memory includes flash memory.

The processor 620 may include at least one core capable of executing at least one instruction. The processor 620 may execute instructions stored in the memory 610. The processor 620 may consist of a single processor or a plurality of processors.

The storage 630 maintains stored data even if power supplied to the computing device 600 is cut off. For example, the storage 630 may include non-volatile memory or may include a storage medium such as a magnetic tape, an optical disk, or a magnetic disk. A program stored in the storage 630 may be loaded into the memory 610 before being executed by the processor 620. The storage 630 may store files written in a program language, and a program created from the files by a compiler may be loaded into the memory 610. The storage 630 may store data to be processed by the processor 620 and/or data processed by the processor 620.

The input/output interface 640 may provide an interface with an input device such as a keyboard or a mouse and/or an output device such as a display device or a printer. The user may trigger execution of a program by the processor 620 through the input device and/or check the processing results of the processor 620 through the output device.

The communication interface 650 may provide access to an external network. The computing device 600 may communicate with other devices through the communication interface 650.

Each element of the apparatus or method in accordance with the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an example description of the technical idea of one embodiment of the present disclosure. In other words, those having ordinary skill in the art to which the technical concepts of the present disclosure belong may appreciate that various modifications and changes can be made without departing from essential features of an embodiment of the present disclosure, i.e., the sequence illustrated in the flowcharts/timing charts can be changed and one or more operations of the operations can be performed in parallel. Thus, flowcharts/timing charts are not limited to the temporal order.

Although embodiments of the present disclosure are described for illustrative purposes, those having ordinary skill in the art will appreciate that various modifications, additions, and substitutions are possible, without departing from the idea and scope of the claimed disclosure. Therefore, embodiments of the present disclosure are described for the sake of brevity and clarity. The scope of the technical idea of the present embodiments is not limited by the illustrations. Accordingly, one having ordinary skill in the art should understand that the scope of the claimed disclosure is not to be limited by the above explicitly described embodiments but by the claims and equivalents thereof.

What is claimed is:

1. A method for controlling integration between a wearable device and a vehicle, the method comprising:
connecting the wearable device and the vehicle using wireless communication;
building a software program or application (an app) optimized for the wearable device based on attribute information of the wearable device and option information of the vehicle;
obtaining location information of the wearable device; and
sending an app deactivation command or an app deletion command to the wearable device based on the location information of the wearable device.

2. The method of claim 1, wherein connecting the wearable device includes:
requesting a user to approve the vehicle to control the wearable device;
storing the attribute information of the wearable device supported by the wearable device; and
registering the wearable device.

3. The method of claim 1, wherein building the app optimized for the wearable device includes:
selecting an application optimized for the wearable device by checking the attribute information of the wearable device.

4. The method of claim 1, wherein building the app optimized for the wearable device includes:
transmitting data of the app optimized for the wearable device; and
instructing the wearable device to install the transmitted app.

5. The method of claim 1, wherein obtaining the location information of the wearable device includes:
checking whether the wearable device is located within the vehicle based on monitoring a location of the wearable device.

6. The method of claim 1, wherein sending the app deactivation command or the app deletion command to the wearable device sends the app deactivation command to the wearable device by considering at least one or more of a wireless signal strength, a wireless positioning, and whether a vehicle door is closed.

7. The method of claim 1, wherein sending the app deactivation command or the app deletion command to the wearable device sends the app deletion command based on an activation time of the app.

8. The method of claim 1, wherein sending the app deactivation command or the app deletion command to the wearable device sends the app deactivation command based on speed information of the vehicle.

9. An apparatus for controlling integration between a wearable device and a vehicle, the apparatus comprising:
at least one memory storing commands; and
at least one processor,
wherein the at least one processor is configured to perform
connecting the wearable device and the vehicle using wireless communication,
building a software program or application (an app) optimized for the wearable device based on attribute information of the wearable device and option information of the vehicle,
obtaining a location information of the wearable device, and
sending an app deactivation command or an app deletion command to the wearable device based on the location information of the wearable device.

10. The apparatus of claim 9, wherein connecting the wearable device includes:
requesting a user to approve the vehicle to control the wearable device;
storing the attribute information of the wearable device supported by the wearable device; and
registering the wearable device.

11. The apparatus of claim 9, wherein building the app optimized for the wearable device includes:
selecting an application optimized for the wearable device by checking the attribute information of the wearable device.

12. The apparatus of claim 9, wherein building the app optimized for the wearable device includes:
transmitting data of the app optimized for the wearable device; and
instructing the wearable device to install the transmitted app.

13. The apparatus of claim 9, wherein obtaining the location information of the wearable device includes:
checking whether the wearable device is located within the vehicle based on monitoring of a location of the wearable device.

14. The apparatus of claim 9, wherein sending the app deactivation command or the app deletion command to the wearable device sends the app deactivation command to the wearable device by considering at least one or more of a wireless signal strength, a wireless positioning, and whether a vehicle door is closed.

15. The apparatus of claim 9, wherein sending the app deactivation command or the app deletion command to the wearable device sends the app deletion command based on an activation time of the app.

16. The apparatus of claim 9, wherein sending the app deactivation command or the app deletion command to the wearable device sends the app deactivation command using a speed information of the vehicle.
